(19) United States
(12) Patent Application Publication
(10) Pub. No.: US 2007/0005436 A1
(43) Pub. Date: Jan. 4, 2007

(54) System and method for receiving orders in an expedited manner

(75) Inventors: David M. Baum, Passaic, NJ (US); Ira L. Lipschitz, Passaic, NJ (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: 800 Brands, Inc., Rochelle Park, NJ (US)

(21) Appl. No.: 11/142,923

(22) Filed: Jun. 2, 2005

(51) Int. Cl. G06Q 30/00

(52) U.S. Cl. 705/26

(57) ABSTRACT

In an on-line purchasing environment, a user is presented with a summary of each of a plurality of items. Upon selection of one of the items by the user, the user is presented with details of the selected item, as well as a list of possible recipients the item is to be sent to and a choice of shipping methods for delivering the item to chosen recipient(s). After receiving a selection of the chosen recipient(s) and shipping method(s) from the user, an order to purchase the item for the chosen recipient(s) via the shipping method(s) is quickly completed. Accordingly, a user may purchase an item for a plurality of recipients quickly and efficiently.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to a system and a method for receiving orders in an expedited manner. In particular, this invention pertains to presenting a list of recipients to a user upon the user's initial selection of an item for purchasing and receiving a selection of one or more recipients from the list of recipients to which the item is to be delivered.

### BACKGROUND OF THE INVENTION

Many of today's consumers shop for items via the Internet. These consumers want to purchase their items quickly and easily. Unnecessary complexity in the purchasing process leads to lost business, often times to a competitor. Conventional purchasing processes are implemented using a sequence of Web pages. A typical conventional purchasing process displays an overview of multiple items on one Web page. When a user selects one of the multiple items, the user is presented with a second Web page that displays details of the selected item, usually with a large image of the item. On this second Web page, the user may add the item to a “shopping cart.” If the user adds the item to his or her shopping cart, the user is presented with a third Web page that reveals a summary of the contents of the user's shopping cart, and the user is able to proceed to “checkout” if he or she is ready to purchase the item. If the user proceeds to checkout, the user is displayed a fourth Web page, where the user is prompted to input billing and recipient address information. After entering billing and recipient address information, the user is presented with a fifth Web page, where the user is displayed a final order summary and is prompted to input payment information, such as credit card information. After inputting the credit card information, the user may then complete the order. Upon completion of the order, the user is presented with a sixth Web page where the user is presented with an order receipt, usually with a confirmation number.

The conventional processes allow a user to ship the purchased item to one recipient per purchasing cycle. For instance, if a user wants to send one item to a first recipient and a second item to a second recipient, the user must go through the purchasing process twice, once for each recipient. Having to repeat the purchasing process for each recipient is cumbersome to the user, especially if the purchasing process involves many steps. Therefore, a need in the art exists for a more efficient purchasing process.

### SUMMARY OF THE INVENTION

The above-described problems are addressed and a technical solution is achieved in the art by a system and a method for receiving orders in an expedited manner according to the present invention. In an embodiment of the present invention, recipient information is received from a user, which includes a list of recipients and their associated addresses to which the user may desire to deliver items. The recipient information may be imported from contact management programs, such as, without limitation, Microsoft Outlook™, Lotus Notes™, ACT!™, Siebel CRM on Demand™, or the contact management portion of Palm OS™. The recipient information is stored in a computer-accessible memory for later retrieval.

Upon the user's initial selection of an item for purchasing, at least a portion of the recipient information is presented to the user so that he or she immediately may decide to which recipient(s) the item is to be delivered. The user also is presented with available delivery methods so that the user may select which delivery method(s) are to be used to deliver the item to the recipient(s). Selection(s) of one or more recipients and one or more delivery method(s) are received from the user. After receiving the selected recipient(s) and delivery method(s), the user is presented with an order summary, which displays at least the item and the item quantity to be shipped to each recipient and the associated delivery method(s). The user may modify item quantities, may modify recipient addresses, may modify delivery methods, may add new or modify default gift messages associated with each recipient, and is prompted to input payment information. Upon receipt of the user's payment information and any modifications, the order is completed. Accordingly, by presenting the recipient information to the user upon the user's initial selection of an item, the user may purchase the item and send it to a plurality of recipients in a single, efficient, purchasing process.

According to another embodiment of the present invention, a history of items ordered for each recipient is stored, and such history may be displayed in whole or in part to the user. Such history may be displayed to the user concurrently with the recipient information displayed upon the user's initial selection of an item for purchasing.

According to a further embodiment of the present invention, important dates associated with each recipient may be stored, such as birthdays and/or holidays. When an important date is approaching, the user may be notified that such date is approaching and which recipient(s) the date is associated with.

According to still another embodiment of the present invention, a user is presented with a first Web page that includes a summary for each of a plurality of items. Upon the user's selection of an item from the plurality of items, the user is presented with a second Web page that displays at least details of the selected item and allows the user to select recipients from the user's recipient information to which the item is to be delivered. The second Web page also allows the user to select the delivery method(s) to be used to deliver the item to the selected recipients. Upon receipt of the selected recipient(s) and the selected delivery method(s), the user is presented a third Web page, which displays the user's “shopping cart” including a summary of all existing orders yet to be purchased. From the third Web page, the user may modify at least the item quantities to be delivered to each recipient. Upon confirmation of the summary displayed on the third Web page, the user is presented a fourth Web page, which displays a default billing address, if known, and/or allows the user to input and/or modify a billing address. The fourth Web page also displays the recipient address associated with each recipient, which the user may modify. Further, the fourth Web page displays default payment information, such as credit card information, if known, and/or allows the user to input and/or modify payment information. Optionally, the fourth Web page displays default gift message(s) associated with each recipient, if known, and/or allows the user to input and/or modify gift messages associated with each recipient. Upon receipt of the payment information and any modifications, the order is complete and the user is displayed a fifth Web page, which includes an order confirmation.

### BRIEF DESCRIPTION OF THE DRAWINGS

The present invention will be more readily understood from the detailed description of preferred embodiments presented below considered in conjunction with the attached drawings, of which:

FIG. 1 illustrates a system for receiving orders, according to an embodiment of the present invention;

FIG. 2 illustrates an address book, according to an embodiment of the present invention;

FIG. 3 illustrates a process for receiving orders, according to an embodiment of the present invention;

FIG. 4 illustrates an item-summary Web page, according to an embodiment of the present invention;

FIGS. 5A and 5B illustrate a selected-item-detail Web page, according to an embodiment of the present invention;

FIG. 6 illustrates an order-summary Web page, according to an embodiment of the present invention; and

FIGS. 7A and 7B illustrate an order-checkout Web page, according to an embodiment of the present invention.

It is to be understood that the attached drawings are for purposes of illustrating the concepts of the invention and may not be to scale.

### DETAILED DESCRIPTION OF THE INVENTION

The present invention expedites and simplifies computer-facilitated purchasing processes by allowing a user to efficiently purchase one or more items for a plurality of recipients in a single purchasing sequence. Although some of the illustrative examples used herein include products being purchased, one skilled in the art will appreciate that the invention also applies to purchasing services. Further, although the illustrative examples used herein often are described in the context of Web pages, one skilled in the art will appreciate that other types of user interfaces may be used to interact with a user.

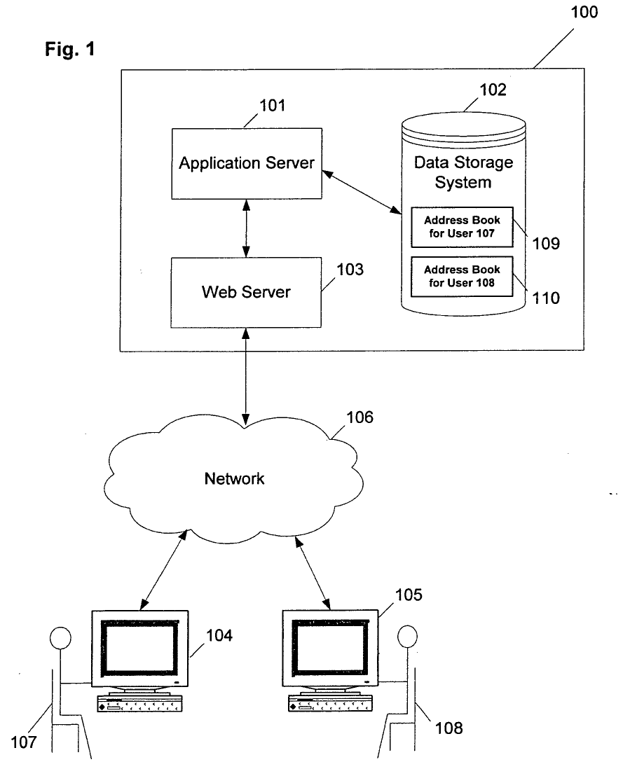

FIG. 1 illustrates a system 100 for receiving orders, according to an embodiment of the present invention. The system 100 includes an application server 101, a data storage system 102, and, optionally, a Web server 103. The application server 101 includes one or more computers that implement the various processes within the scope of the present invention for receiving orders for purchasing items. The term “computer” is intended to include any data processing device, such as a desktop computer, a laptop computer, a mainframe computer, a personal digital assistant, a Blackberry, and/or any other device for processing data, and/or managing data, and/or handling data, whether implemented with electrical and/or magnetic and/or optical and/or biological components, or otherwise.

The application server 101 is communicatively connected to a data storage system 102. The data storage system 102 includes one or more computer-accessible memories and stores various information needed by the application server 101 to execute its processes, such as user address books 109, 110 belonging to users 107, 108, respectively. The phrase “computer-accessible memory” is intended to include any computer-accessible data storage device, whether volatile or nonvolatile, electronic, magnetic, optical, or otherwise, including but not limited to, floppy disks, hard disks, CD-ROMs, DVDs, flash memories, ROMs, and RAMs. The phrase “communicatively connected” is intended to include any type of connection, whether wired, wireless, or both, between devices and/or programs in which data may be communicated. Further, the phrase “communicatively connected” is intended to include a connection between devices and/or programs within a single computer, a connection between devices and/or programs located in different computers, or a connection between devices not located in computers at all. In this regard, although data storage system 102 is shown separately from the application server 101, one skilled in the art will appreciate that the data storage system 102 may be located completely or partially within the application server 101.

Optionally, the application server 101 is communicatively connected to the Web server 103. The Web server 103 may include one or more computers configured to act as an interface between the application server 101 and client computers 104, 105 via the network 106, which may be the Internet. In particular, the Web server 103 receives requests from client computers 104, 105 and forwards them to the application server 101. The application server 101 processes the requests and transmits responses to the Web server 103, which forwards the responses to the appropriate client computers 104, 105. The Web server 103 may include a firewall, known in the art, to protect the application server 101 from malicious communications from the user computers 104, 105. Although shown separately, the Web server 103 may be a program executed by a computer acting as the application server 101. Further, in some configurations, the Web server 103 is unnecessary. Although two client computers 104, 105 are shown in FIG. 1, one skilled in the art will appreciate that any number of client computers may exist.

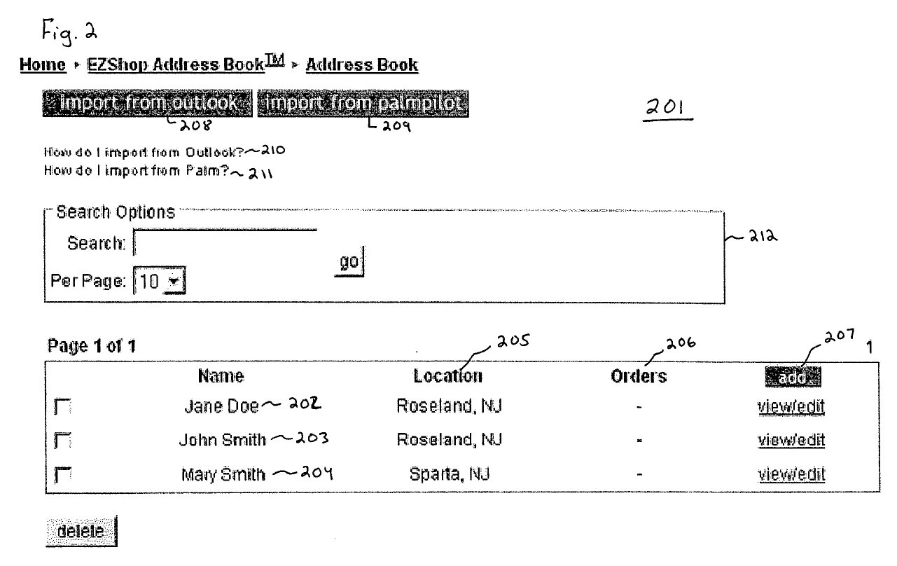

FIG. 2 illustrates a Web page 201, according to an embodiment of the present invention, which in this example, is presented to a user 107 of the client computer 104 by the application server 101. Although the following examples refer to interactions with the user 107, one skilled in the art will appreciate that the same interactions may occur with any other user. The Web page 201 allows the user 107 to input recipient information stored as a personal address book 109 in the data storage system 102. The recipient information may include a name, address, phone number(s), and email address(es) for each recipient in the address book 109. In the embodiment of FIG. 2, the user 107, referred to as “John Doe” throughout the following examples, already has input three recipients, referred to herein as possible recipients of purchased items, into his address book 109: Jane Doe 202, John Smith 203, and Mary Smith 204. The user 107 can search his list of possible recipients using a search box 212.

Each possible recipient's city and state of residence is shown in a location column 205. Although only a city and state of residence is shown in the location column 205, one skilled in the art will appreciate that other recipient information may be displayed in the location column 205. The Web page 201 also may include an order history and/or pending orders for each possible recipient shown in an order column 206. In this example, no pending or completed orders exist for the recipients 202-204.

The user 107 may input a new possible recipient to the address book 109 by selecting an “add” button 207, which presents another Web page to the user 107 that allows the user 107 to manually input the new recipient information. Alternatively, the user 107 may input one or more possible recipients by importing recipient information from a contact management program, such as, without limitation, Microsoft Outlook™, Lotus Notes™, ACT!™, Siebel CRM on Demand™, or the contact management portion of Palm OS™. Such importation may occur by having the contact management program export a comma-delimited file or other file understandable by the application server 101. In the embodiment of FIG. 2, the user 107 may initiate importation of recipient information from Microsoft Outlook™ by clicking the “import from outlook” button 208. Alternatively, the user 107 may initiate importation of recipient information from a Palm device by clicking the “import from palmpilot” button 209. Assistance on importing recipient information may be provided to the user 107 via links 210, 211.

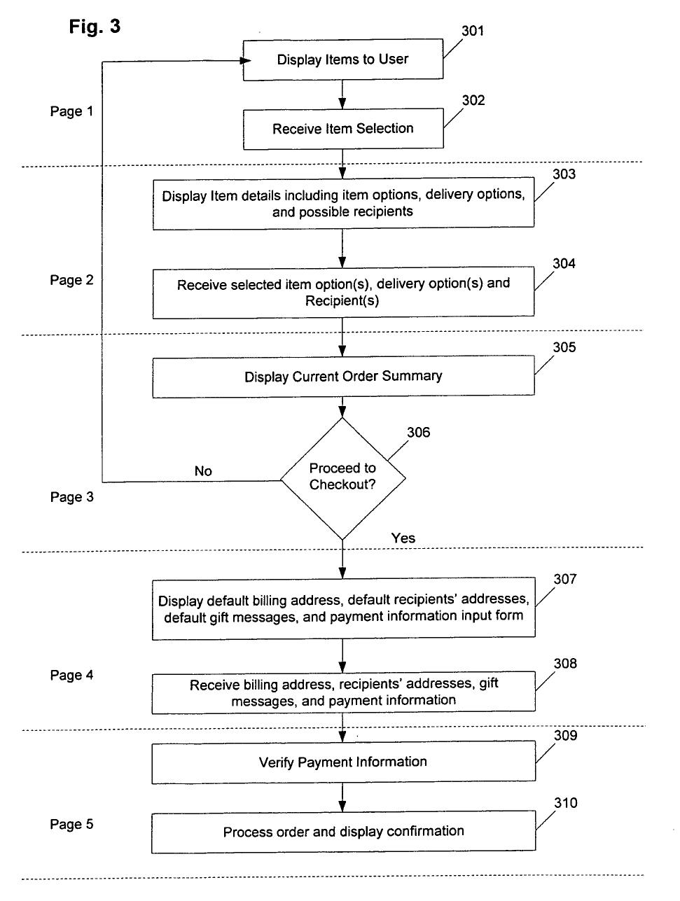

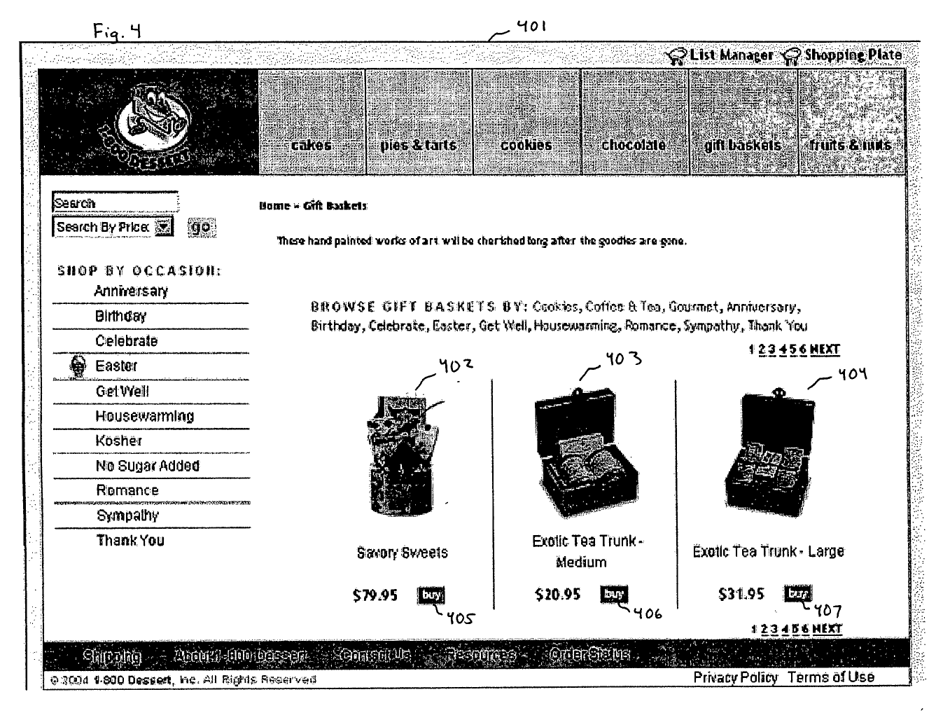

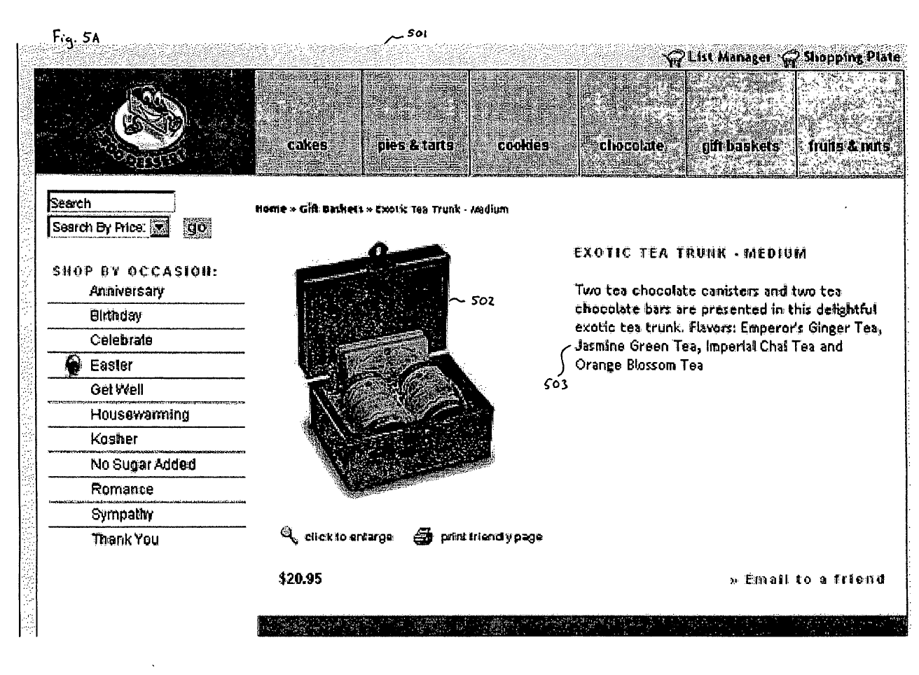

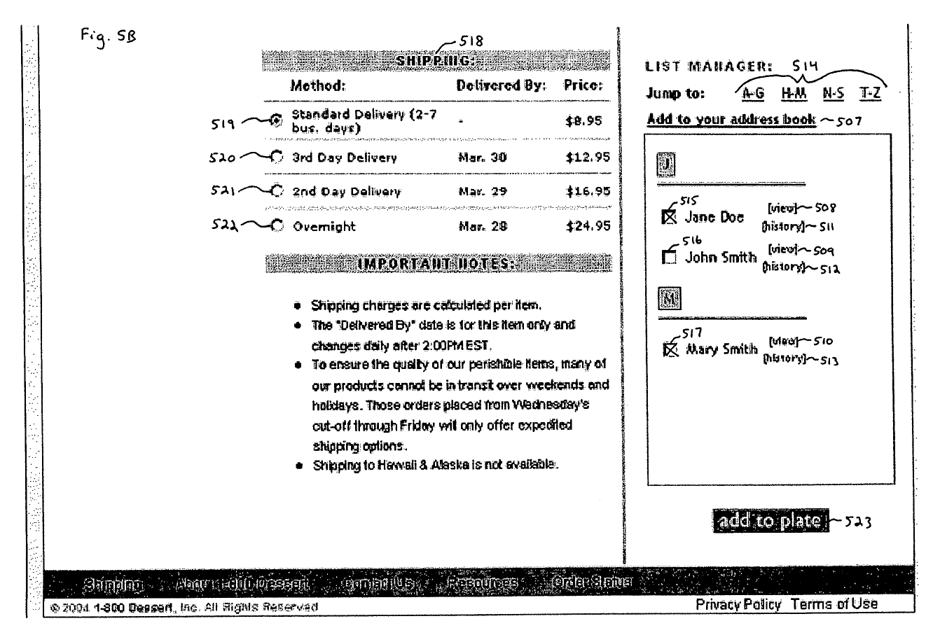

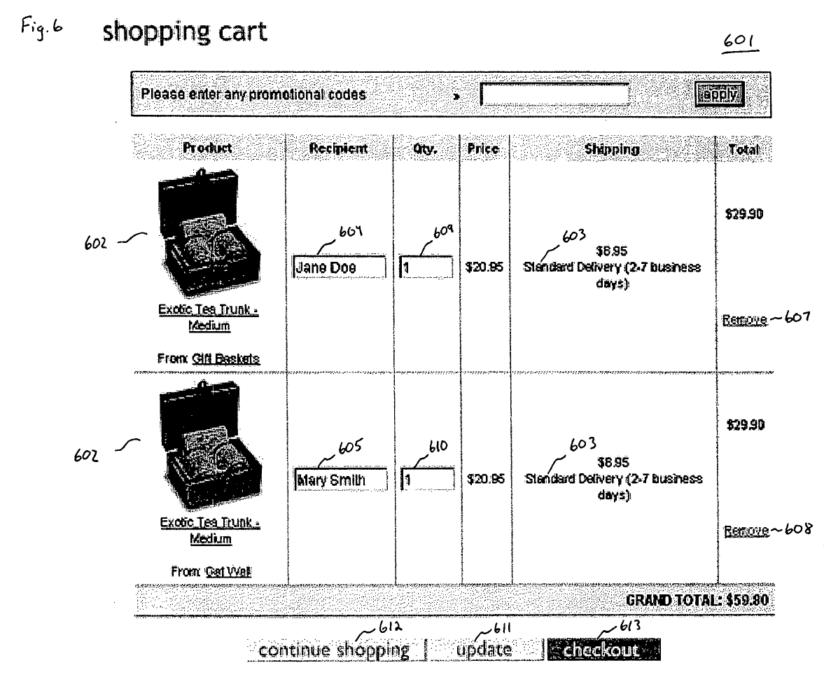

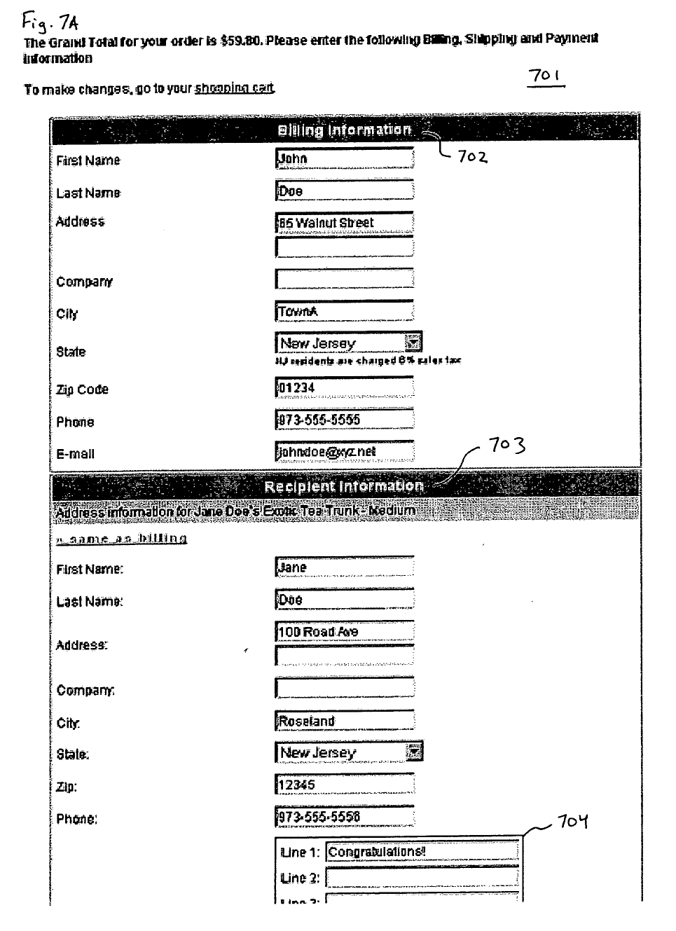

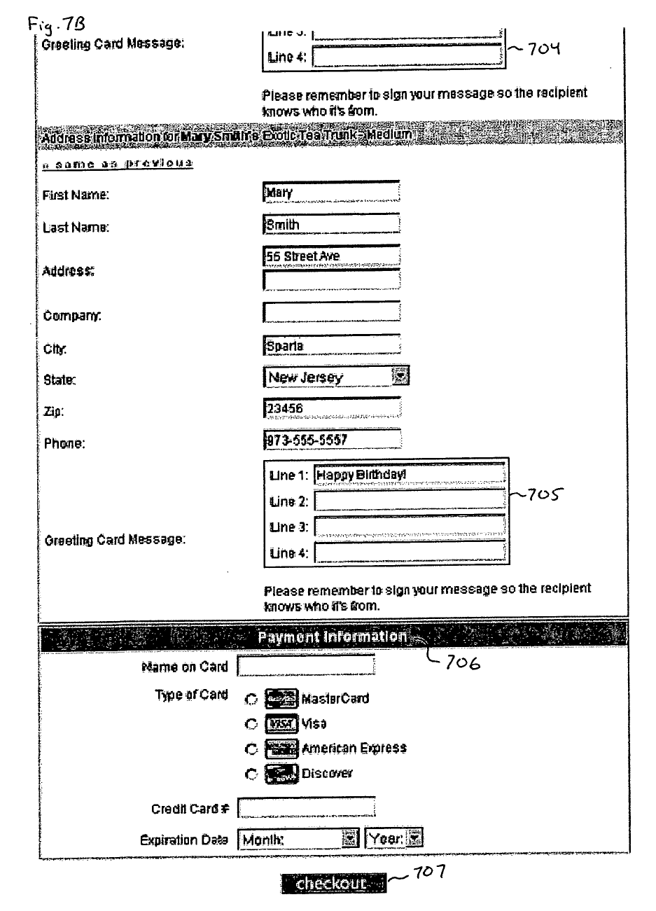

FIG. 3 illustrates a process for receiving orders, according to an embodiment of the present invention, which utilizes the recipient information stored in the address book 109, for example. FIG. 3 will be described in conjunction with the remaining figures, which illustrate examples of interfaces for use with the process described with respect to FIG. 3, according to various embodiments of the present invention. In particular, steps 301, 302 are associated with a first Web page shown in FIG. 4; steps 303, 304 are associated with a second Web page shown in FIGS. 5A and 5B; steps 305 and 306 are associated with a third Web page shown in FIG. 6; and steps 307, 308 are associated with a fourth Web page shown in FIGS. 7A and 7B. Steps 309, 310 also may be associated with a Web page, not shown.

At step 301, a summary for each of a plurality of items that may be purchased are presented to the user 107. According to an embodiment of the present invention, these summaries are presented via a Web page 401 shown in FIG. 4. The Web page 401 includes a summary of three items 402-404. The summary of item 402 includes a picture of the item, a short description, “savory sweets,” and a price of $79.95. The summary of the item 403 similarly includes a picture, a short description, “Exotic Tea Trunk—Medium,” and a price of $20.95. The summary of the item 404 follows the same pattern with a picture, a short description, “Exotic Tea Trunk—Large,” and a price of $31.95.

At step 302 in FIG. 3, the application server 101 receives a selection of an item that may be purchased. In the embodiment of FIG. 4, if the user 107 is interested in purchasing one of the items 402-404 described on the Web page 401, the user 107 selects the corresponding “buy” button 405-407. When one of the “buy” buttons 405-407 is selected, a message indicating that the corresponding item has been selected is transmitted from the client computer 104, through the network 106, through the Web server 103, if present, and to the application server 101, which receives an item-selection message at step 302.

Upon receipt of the item-selection message at step 302, the application server 101 presents at least a detailed summary of the selected item and the possible recipients in the address book 109 to the user 107 at step 303. The information presented at step 303 also may include options associated with the item and available delivery options for delivering the item, such as by e-mail, regular mail, priority mail, express mail, etc.

In the embodiment of FIGS. 5A and 5B, the information presented at step 303 is displayed with a Web page 501. The details of the item selected at step 302, in this case, the item 403, include a larger image 502 of the item 403, and a detailed description 503. The Web page 501 also includes the possible recipients 504-506 from the address book 109. The user 107 selects which of the possible recipients 504-506 he wishes to send the selected item to by checking the appropriate check boxes 515-517. Although check boxes 515-517 are shown on Web page 501, one skilled in the art will appreciate that the invention is not limited to any particular mechanism for selecting recipients. In this example, the user 107 has selected Jane Doe 504 and Mary Smith 506.

In the embodiment of FIGS. 5A and 5B, only the names of each possible recipient 504-506 are shown. One skilled in the art, however, will appreciate that all or part of the recipient information from the address book 109 may be presented. The user 107 may add one or more new possible recipients to his address book 109 by selecting the link 507. The user 107 also may edit particular recipient information in his address book 109 by selecting the corresponding “view” link 508-510. Further, the user 107 may view a history of previous items sent to each respective possible recipient 504-506 by selecting the corresponding “history” link 511-513. For instance, selecting the link 513 may reveal a Web page that shows the user 107 that he sent a box of chocolates to Mary Smith a year ago for her birthday. The Web page 501 may also provide various ways for the user 107 to search his list of possible recipients 504-506 such as by a series of “Jump to” links 514, which allow the user 107 to view recipients whose names begin with a particular letter.

The Web page 501 may include delivery options 518 for delivering the selected item to the selected recipients 504, 506. In this example, the user 107 may choose to deliver the item to the selected recipients 504, 506 via a standard delivery 519, which takes two to seven business days, a third day delivery 520, a second day delivery 521, and an overnight delivery 522. One skilled in the art will appreciate, however, that the invention is not limited to any particular delivery method for a product or service. Also in this example, the user 107 has selected standard delivery 519. Although the selection of one of the delivery options 518 are shown to apply to all selected recipients 504, 506, one skilled in the art will appreciate, that a different delivery option may be chosen for each selected recipient 504, 506.

Although not shown in FIGS. 5A and 5B, item options may be displayed on the Web page 501. For instance, if the item is a tea trunk, the user 107 may be able to select which types of tea are included in the tea trunk. Or, the user 107 may be able to select which color the tea trunk is to have. Further, the user 107 may be able to select different options for different recipients.

At step 304, the selections of the user 107 from the item options, if applicable, recipients, and delivery methods presented at step 303 are received by the application server 101. In the embodiment of FIGS. 5A and 5B, the user 107 clicks an “add to plate” button 523, which initiates the transmission of one or more messages from the client computer 104 to the application server 101 indicating that the user 107 has selecting recipients 504, 506, and delivery method 519. Upon receipt of such message(s), the application server 101 transmits information used to present an overall summary of the selected items queued for purchasing. This overall summary may include the item selected at step 302 as well as previously selected items.

In the embodiment of FIG. 6, the overall summary is presented via a Web page 601, which includes the selected exotic tea trunk item 602 to be delivered via standard delivery 603 to the selected recipients Jane Doe 604 and Mary Smith 605. If the user 107 does not wish to purchase an item shown on the Web page 601, he may remove it by selecting the corresponding “remove” link 607, 608. The user 107 may change the quantity of the selected item 602 that is to be delivered to each recipient 604, 605, by modifying the corresponding quantity fields 609, 610. The user 107 also may change the recipients 604, 605 and/or delivery methods 603, if desired. Prices may be recalculated to reflect changes in quantity and/or delivery methods by selecting the “update” button 611.

At step 306, it is determined whether the user 107 desires to proceed to purchase the items 602 (“proceed to checkout”) or continue shopping for additional items. In the embodiment of FIG. 6, the user 107 may indicate his intent to continue shopping by selecting the “continue shopping” button 612. In such a case, the application server 101 returns to step 301. In the embodiment of FIG. 6, the user 107 may indicate his intent to continue with purchasing the items 602 by selecting a “checkout” button 613. In this case, the application server 101 proceeds to step 307.

At step 307, the user 107 is prompted to input and/or verify billing information, recipient information, payment information, and, optionally, gift message information. In the embodiment of FIGS. 7A and 7B, the user 107 is prompted to input such information via a Web page 701. Billing information may be displayed in a billing information form 702, which may be initially populated with default billing information previously acquired through a user registration process. If no default billing information is known, the form 702 may be blank. Regardless, the user 107 may input and/or modify the billing information in the form 702, such billing information including a name, address, and, optionally, a company, phone number, and email address of the purchaser.

The Web page 701 also includes recipient information for each of the selected recipients in a recipient information form 703, which is initially populated with the recipient information associated with the user 107 and stored in the data storage system 101. The user 107 may input and/or modify the recipient information in the form 703. Changes to the recipient information in the form 703 may be saved to the address book 109 of the user 107. In the embodiment of FIGS. 7A and 7B, the recipient information includes the name, address, company, and phone number for the selected recipients Jane Doe and Mary Smith.

Optionally, a gift message form 704, 705 may be displayed for each of the selected recipients and may be initially populated with a default message previously identified by the user 107 and stored in the data storage system 102. A single default gift message may be prepared for all recipients, or individual default gift messages may be prepared for each of the possible recipients. The user may input and/or modify the gift messages displayed in the forms 704, 705.

The Web site 701 includes a payment information form 706, which may be initially populated with default payment information previously input by the user 107 and stored in the data storage system 102. Otherwise, the payment information form 706 initially is blank. The user 107 may input and/or modify the payment information in the form 706.

One or more messages indicating the user's completion of inputting and/or modifying and/or reviewing the billing information, the recipient information, the gift message information, if applicable, and the payment information is received at step 308. In the embodiment of FIGS. 7A and 7B, the user 107 indicates such completion by selecting a “checkout” button 707, which initiates transmission of a message with the billing information, the recipient information, the gift message information, if applicable, and the payment information from the client computer 104 to the application server 101.

Upon receipt of the information at step 308, the payment information is verified at step 309. If the payment information is not verified, an error message may be presented to the user 107. If the payment information is verified, processing advances to step 310, where the order is approved and processed. A confirmation message may be presented to the user 107 at such time, optionally, via a Web page.

Although FIG. 3 has been described as having a sequence of Web pages, one skilled in the art will appreciate that one or more Web pages may be presented to a user in between the Web pages described herein. For instance, one or more Web pages with advertisements may be displayed in-between the Web pages described herein. Accordingly, the invention is not limited to the Web pages described herein being presented in any particular sequence except that the purchasing process should progress over time. Preferably, the purchasing process should progress quickly to ensure that users are not unduly burdened by the purchasing process.

Further, although the Web pages described herein are shown to have particular information shown on them, one skilled in the art will appreciate that such information may not be displayed or may be displayed on other Web pages. For instance, shipping options need not be displayed on Web page 501 and could be displayed on another Web page, such as Web page 601. Or, gift messages need not be displayed on Web page 701 and, instead, could be displayed on Web page 601. Further still, although the Web pages described herein have a particular format for displaying information, one skilled in the art will appreciate that the invention is not limited to any particular format.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

What is claimed is:

1. A method for receiving orders, the method comprising the steps of:
receiving a selection of an item for purchasing;
storing the selection of the item in a computer-accessible memory;
upon receipt of the selection of the item, transmitting recipient information including a plurality of possible recipients of the item;
receiving a selection of a plurality of recipients from the plurality of possible recipients; and
processing an order to provide the item to each of the selected recipients.

2. The method of claim 1, wherein the recipient information further includes address information associated with each of the plurality of possible recipients, and wherein the method further comprises the steps of:
receiving the recipient information prior to the step of receiving the selection of the item for purchasing; and
storing the recipient information in a computer-accessible memory.

3. The method of claim 2, wherein the recipient information is received from a contact management program.

4. The method of claim 3, wherein the contact management program is Microsoft Outlook™, Palm OS™, ACT!™, or Siebel CRM on Demand™.

5. The method of claim 1, wherein the item is a product or a service.

6. The method of claim 1, further comprising the step of transmitting delivery information with the recipient information, wherein the delivery information includes possible delivery options for delivering the item to each of the selected recipients.

7. The method of claim 1, further comprising the step of providing access to an order history associated with each of the plurality of recipients.

8. The method of claim 1, further comprising the steps of:
receiving important dates associated with at least one of the plurality of recipients;
storing the important dates in a computer-accessible memory; and
transmitting a notification when at least one of the important dates is approaching within a preset interval of time.

9. The method of claim 1, further comprising the step of receiving a gift message to be provided to at least one of the selected recipients along with the item.

10. A method for receiving orders via a Website that include a plurality of Web pages, the method comprising the steps of:
presenting a first Web page that includes a summary for each of a plurality of items that may be purchased;
receiving a selection of an item from the plurality of items for purchasing;
presenting, upon receipt of the selection of the item, a second Web page that displays at least details of the selected item and a plurality of possible recipients of the selected item;
receiving a selection of a plurality of recipients of the item from the plurality of possible recipients; and
processing, subsequent to receiving the selection of the plurality of recipients, an order to provide the item to each of the selected recipients.

11. The method of claim 10, further comprising the step of receiving recipient information including the plurality of possible recipients and address information associated with each of the plurality of possible recipients, wherein the recipient information is received prior to the step of receiving the selection of the item for purchasing.

12. The method of claim 11, wherein the recipient information is received from a contact management program.

13. The method of claim 12, wherein the contact management program is Microsoft Outlook™, Palm OS™, ACT!™, or Siebel CRM on Demand™.

14. The method of claim 10, wherein the second Web page further displays delivery methods available to deliver the item, and the method further comprises the step of receiving a selection of a delivery method from the available delivery methods, wherein the processing step processes the order by providing the item to at least one of the selected recipients via the selected delivery method.

15. The method of claim 14, wherein the selected item is a currently selected item and the method further comprises the step of presenting, upon receipt of the selection of the plurality of recipients and the selection of the delivery method, a third Web page, which displays a summary of previously selected items and the currently selected item.

16. The method of claim 15, further comprising the steps of:
receiving an indication that the summary displayed on the third Web page, in a modified form or an unmodified form, is approved; and
presenting, upon receipt of the indication, a fourth Web page, which displays at least billing address information, recipient address information including an address for each of the selected recipients, and payment information.

17. The method of claim 16, wherein the fourth Web page further displays gift message information associated with each of the selected recipients.

18. The method of claim 16, further comprising the step of receiving approval of at least the billing address information, the recipient address information, and the payment information, in a modified form or an unmodified form prior to processing the order in the processing step.

19. The method of claim 15, wherein at least one Web page is displayed between the second Web page and the third Web page.

20. A method for receiving orders via a Website that includes a plurality of Web pages, the method comprising the steps of:
receiving recipient information from a contact management program, wherein the recipient information includes a plurality of possible recipients and address information associated with each of the plurality of possible recipients;
presenting a first Web page that includes a summary for each of a plurality of items that may be purchased;
receiving a selection of a currently selected item from the plurality of items for purchasing;
presenting, upon receipt of the selection of the currently selected item, a second Web page that displays at least details of the currently selected item, at least some of the plurality of possible recipients of the currently selected item, and delivery methods available to deliver the currently selected item;
receiving a selection of a plurality of recipients to receive the currently selected item from the plurality of possible recipients and a selection of a delivery method from the available delivery methods;
presenting, upon receipt of the selection of the plurality of recipients and the selection of the delivery method, a third Web page, which displays a summary of previously selected items and the currently selected item;
receiving an indication that the summary displayed on the third Web page is approved in a modified form or an unmodified form; and
presenting, upon receipt of the indication, a fourth Web page, which displays at least billing address information, an address for each of the selected recipients from the address information, and payment information;
receiving approval of at least the billing address information, the recipient address information, and the payment information, in a modified form or an unmodified form; and
processing an order to provide the item to each of the selected recipients via the selected delivery method and to charge a fee according to the payment information.

21. A first computer-accessible memory storing computer code for receiving orders, wherein the computer code comprises:
code for receiving a selection of an item for purchasing;
code for storing the selection of the item in a computer-accessible memory region, wherein the computer-accessible memory region is within the first computer-accessible memory or is within another computer-accessible memory;
code for transmitting recipient information upon receipt of the selection of the item, the recipient information including a plurality of possible recipients of the item;
code for receiving a selection of a plurality of recipients from the plurality of possible recipients; and
code for processing an order to provide the item to each of the selected recipients.

22. A computer-implemented order placement method, comprising the steps of:
providing a Web site with a Web page for a user to select an item to be purchased from a plurality of items;
accessing an electronic address book of the user;
displaying a list of names from the electronic address book on a Web page of the Web site; and
receiving a plurality of orders from the user based on an item selected from the plurality of items and a plurality of recipients selected from the list of names,
wherein the list of names is displayed on a Web page that displays the item selected from the plurality of items.
